(19) United States
(12) Patent Application Publication
(10) Pub. No.: US 2018/0120910 A1
(43) Pub. Date: May 3, 2018

(54) SYSTEM AND METHOD TO MANAGE POWER FOR PORT CONTROLLER BASED POWER SUPPLIES USING A COMMON POWER SOURCE

(71) Applicant: SEMTECH CORPORATION, Camarillo, CA (US)

(72) Inventors: Thomas Farkas, Chapel Hill, NC (US); Ross E. Teggatz, The Colony, TX (US); David J. Baldwin, Allen, TX (US)

(21) Appl. No.: 15/803,438

(22) Filed: Nov. 3, 2017

Related U.S. Application Data
(60) Provisional application No. 62/417,283, filed on Nov. 3, 2016.

(51) Int. Cl. G06F 1/18; H02J 7/00; G06F 1/26

(52) U.S. Cl. CPC G06F 1/189; H02J 7/0022; H02M 7/04; H02J 7/0026; G06F 1/26

(57) ABSTRACT

A system that delivers power between a common power source having a total deliverable system power and device loads. The system includes a power share interface that sums power consumed or requested by loads and determines availability of additional power. The system includes at least one peer power share interface with each peer interface associated with a port controller and communicable coupled to the power share interface over the system bus. The peer power share interface determines status of total power consumed or requested relative to total deliverable system power. The power share interface can in response to receiving the power level request cause the system to change power allocations to satisfy the power level requests.

### CROSS REFERENCE TO RELATED APPLICATION

This present application claims priority to U.S. Provisional Patent Application No. 62/417,283, filed Nov. 3, 2016, entitled “System and Method to Manage Power Delivery Contracts Negotiated by Multiple Power Supplies with a Common Limited Power Source,” the entire contents of which is hereby incorporated by reference for all purposes as if set forth herein in its entirety.

### TECHNICAL FIELD

The present disclosure relates generally to power management, and more specifically to a system and method to manage power delivery from a common limited power source to device loads through multiple port controllers of power supplies.

### BACKGROUND OF THE INVENTION

Management of power supplies is known in the art, but is typically based only on load requirements and the capability of the powers supply. Additionally, in the case of system devices, such as power stations, laptop computers, and mobile phones, that supply power to the device load using USB based systems and connection ports, it can be a difficult task to adequately deliver power that satisfies the needs of a particular device. The task becomes more difficult as power stations, laptop computers, and mobile devices evolve to allow for the delivery of power to a multitude of device loads wherein the power delivered can come from a single power source and the device loads attached thereto each can have unique and time-varying power requirements. A need exists to provide for supply side management of the delivery of the power to the load from the common power source and optimize the charging of batteries in the host system and in the external device loads.

### SUMMARY OF THE INVENTION

A system is provided for controlling and delivering power between a common power source having a total deliverable power capability and multiple device loads connected to the ports of power supplies in the system. The system can operate efficiently and dynamically and in conjunction to manage power provided over each port so that additional power can be delivered to a device that may need the additional power. The system includes a port controller and power sharing interface associated with each power supply. The port controller is communicable coupled with the device associated with a respective power supply and the power sharing interface is communicable coupled with the port controller and peer power sharing interfaces associated with peer power supplies. The port controllers and power sharing interfaces can operate in conjunction to efficiently and dynamically manage the total system power to satisfy the power needs of the device loads in response to signaling from the devices.

In an embodiment, the system manages and delivers power between a common power source having a total system power and device loads. The system comprises a power share interface for one or more port controllers for port power supplies that determine the power level being consumed by the device loads. In response to this determination, the power share interface communicates over a system bus the total power consumption from the ports. Any of the port controllers can receive a power level request from a device load and, in response, the power share interface causes the system to re-allocate power as needed to satisfy the power level request.

In another embodiment, the system comprises at least one peer power share interface with each power share interface associated with a port controller of a power supply and communicable coupled to the power share interface over the system bus. The peer power share interface determines power consumed by a device load of an associated power supply and, in response, communicates the power consumed over the system bus. The power share interface determines, in response to receiving the power level request, available system power and, in response, causes the system to redirect additional power as needed to satisfy the power level requests.

In yet another embodiment, the system further comprises the power share interface. The system determines available system power and, in response, sends a power negotiation request to at least one peer power share interface over the system bus and at least one peer power share interface, in response, causes the associated port controller to send a power level adjustment request to a device load associated with the associated power supply.

In another embodiment, the power level adjustment request is sent if the peer power share interface, peer power supply, associated load, or associated port controller is of a lower priority than the initiating power share interface, power supply, associated load, or port controller. In addition, the system bus is a single wire connection. Furthermore, the system bus connects through a single resistor to a reference voltage that is common for all power supplies. Furthermore, the resistor value is inversely proportional to the maximum power that the set of power supplies can collectively draw from the common power source.

In another embodiment, a battery charger in the system uses the power sharing interface to adjust how much power it draws from the power bus shared with port power supplies.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 depicts an example graph of load profiles in a 40 W system where individual loads draw variable powers up to 30 watts, according to certain example embodiments;

FIG. 2 depicts a generalized multi-port power system to manage power sharing among multiple power supplies, according to a certain embodiment;

FIG. 3 depicts a system in which the input power source feeds 3 USB power supplies, according to certain example embodiments;

FIG. 4 depicts a system for power sharing via current sources in the Local Policy Manager (LPM) of each USB power supply (or USB port) controller and optionally in the controller for the input supply, in certain example embodiments;

FIG. 5 depicts an example embodiment of PSHARE terminal voltages and currents of 3 power supply controllers under a priority-based delay scheme when 3 loads simultaneously request power;

FIG. 6 depicts a current ramping scheme as applied to the scenario of 3 loads all requesting power at the same time, in certain example embodiments;

FIG. 7 depicts a diagram showing the utilization of the voltage range of a PSHARE pin with combined enable/disable and programming/test mode functions, according to certain example embodiments;

FIG. 8 depicts a multiport power system with bidirectional power flow, according to certain example embodiments;

FIG. 9 depicts a diagram of a PSHARE bus signal with any of the systems presented herein, according to certain example embodiments;

FIG. 10 depicts a typical charging profile for a Lithium ion battery, as commonly used in a cellphone that might be supplied by a port side power supply, according to certain example embodiments;

FIG. 11 depicts a multi-port power supply system working with a battery-powered system including a battery charger interface, according to certain example embodiments;

FIG. 12 depicts an interface system with charging optimization to work with low voltage current sources on port power supply controllers, according to certain example embodiments;

FIG. 13 depicts an alternative embodiment of the interface system, according to certain example embodiments; and

FIG. 14 depicts a USB-PD System with wall-power display serving as a power hub for a notebook computer and a smart phone, according to certain example embodiments.

### DETAILED DESCRIPTION OF THE PREFERRED EMBODIMENTS

In the description that follows, like parts are marked throughout the specification and drawings with the same reference numerals. The drawing figures may not be to scale and certain components can be shown in generalized or schematic form and identified by commercial designations in the interest of clarity and conciseness.

The example embodiments presented herein are directed to system, methods, and apparatus products for use with USB port controllers for controlling and delivering power from a common, limited power source to USB load devices over USB ports. In a system with multiple output power ports, convenience and usability are improved by allowing each of the ports to be used with a variety of loads which may draw a high power such that the system could not support that power level at each of the ports simultaneously. The desired power level at an individual port may even be as high as the total power capability of the system, but in any case, the total system power provided to a combination of ports can be intelligently controlled so that a range of power levels can be administered over a different combination of ports. System controls and communications are required in such a system to quickly determine whether a requested amount of loading can be supported and to prevent overload of the input source, which could otherwise result in interruptions to the power at one or more ports and disturbances to system operation. The present disclosure provides an efficient and simple system and method to make this determination and respond to power requests, giving advantages of a good user experience and reduced requirements, i.e. lower cost, for the port controller. One unique aspect of the system is that it uses a single wire connection among multiple power supply controllers to manage the allocation of limited available power from a shared input source. The embodiments described herein can be applied to the Universal Serial Bus Power Delivery (USB-PD) application or other suitable applications. USB-PD is an industry standard developed by the USB-IF (Universal Serial Bus Implementers Forum) for devices to communicate, and transfer power via USB Type C cables.

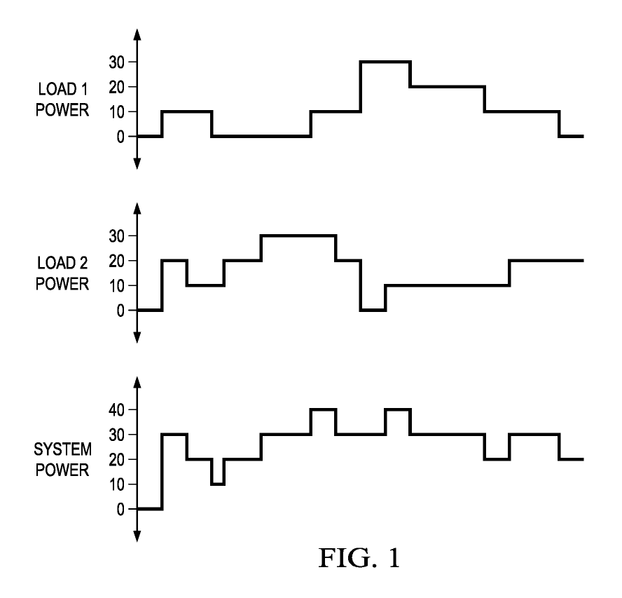

One or more USB power delivery controllers can be used to manage multiple power supplies so as to draw power from a shared input power supply and in turn source power to respective USB ports. The controllers and associated interfaces presented herein are applicable to any suitable set of power converters, such as those with flexible loads and sharing a common input power supply that has a total power capability less than the sum of the maximum power levels that could be offered by each individual power supply. As an example, FIG. 1 shows load profiles of an example system where there are two loads, each of which may draw up to 30 watts at times but not both at the same time. To match a limited input power source capability, the system manages the power supplies to keep the total power under 40 watts at any given time. In such a system, the common input source can be an AC-to-DC converter operated from an AC supply; a battery or other suitable energy storage device; some other suitable DC power source such as a solar panel or fuel cell based system; or a suitable power converter that provides conditioning, conversion, regulation, and/or protection between one of these sources and the USB power supplies. The flexible loads can be battery chargers that can adjust their charging power to match what is available, or other loads that can shed, schedule or postpone power-consuming activities.

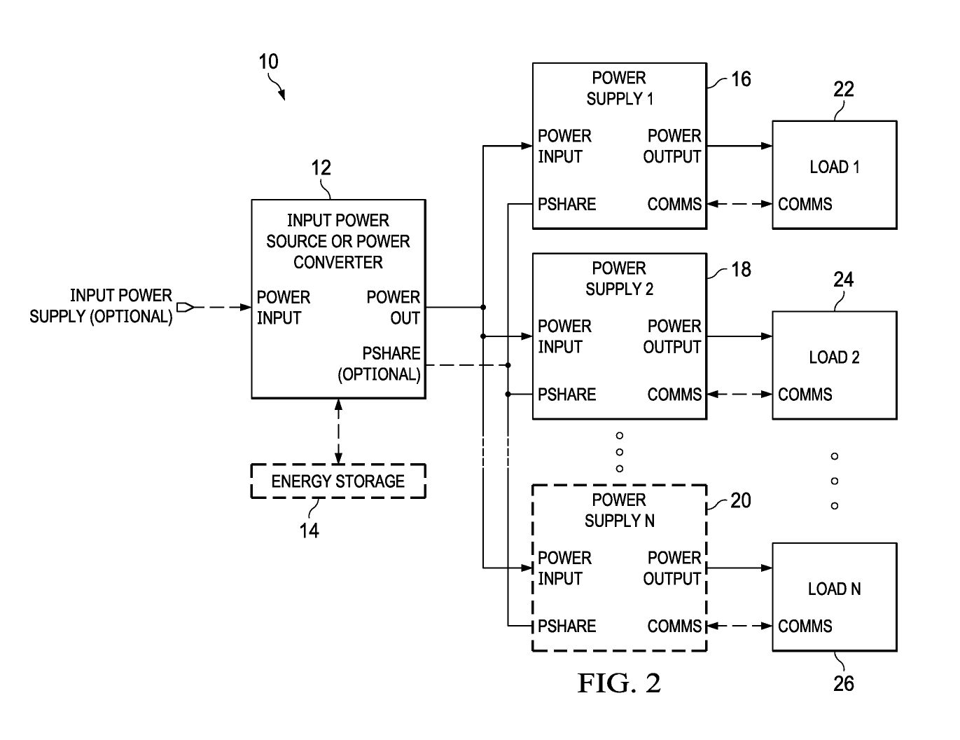

Referring now to FIG. 2, illustrated is a generalized multi-port power system to manage power sharing among multiple power supplies, according to a certain embodiment, denoted generally as 10. In this embodiment, the system comprises a common power source 12 that can be fed by another input power supply, an optional battery 14, multiple power supplies 1-N, designated here as 16, 18, and 20, and device loads 1-N, designated here as 22, 24, and 26, respectively. The power supplies 16, 18, 20 receive input power from the common power source 12 over respective input connections and communicate power needs and other relevant information over a connection designated as PSHARE. The PSHARE connection can be a a single-wire. The common input power source 12 can be a power converter connected to the AC input power supply, a stand-alone power source drawing power from a battery 14 or local (fuel-fed) power generation equipment incorporated into the power source, or other suitable common input power source. The power source itself could be a battery or battery pack with no power converter, or other suitable power source. The power output can be electrical, another form such as mechanical or hydraulic, or other suitable power output. This input power source feeds power to 2 or more power supplies that each control the power allowed by a load. This control may include communication of allowed power limiting, active limiting of power, shutdown in the event that allowed power is exceeded, or some combination of these controls. The power supplies can have multiple loads with multiple PSHARE connections corresponding to the respective loads. Some of the loads can be aggregated by the power supply to correspond to a single PSHARE connection, or other suitable configurations can be used. In any case, loads can be aggregated to be represented by a model such as in FIG. 2. In some cases, one or more of the device loads 22, 24, and 26 can act as a power source and the respective power supply 16, 18, or 20 can receive power at the corresponding output, either as its primary function or utilizing a bidirectional power flow capability. In this case, power would flow from one of the power inputs of the power supply 16, 18, or 20 to the shared bus connecting these power inputs to the Power Out terminal of the common input source 12. Some or all of this power might be drawn by one of the other power supplies to feed its load. Alternately, or additionally, some or all of this power might be drawn by the power source to store energy (such as in a battery) or to support it's internal “housekeeping” power needs.

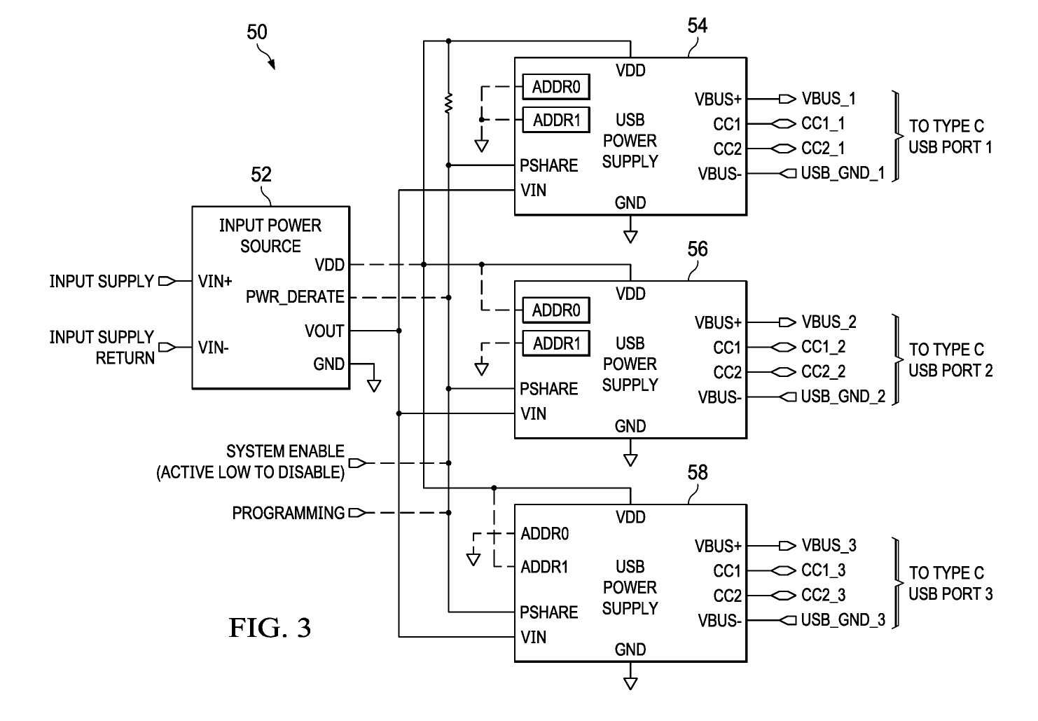

Referring to FIG. 3, illustrated is an example of a system in which the input power source feeds 3 USB power supplies, according to certain example embodiments, denoted generally as 50. In this example embodiment, the system 50 includes an input power source 52 and power supplies 54, 56, and 58 coupled to the input power source 52. In this embodiment, each power supply 54, 56, and 58 is connected to a port for a USB type C connector in accordance with the USB Power Delivery standard. According to the USB Power Delivery 3.0 protocol, the CC1_x and CC2_x lines of each port are used for device identification and for communication with the connected device. The standard uses the terms “source”, “sink”, or “dual role power” to describe the power flow capabilities of each port. The USB power supplies 54, 56, and 58 can be based on any suitable power conversion topology. The USB power supplies 54, 56, and 58 of FIG. 3 include separate grounds, USB_GND_x, for the USB port output of each supply and for the input source (Vᵢₙ), which allows for an isolated power circuit topology such as a forward or flyback converter. However, in certain embodiments, the power circuit of the USB power supplies 54, 56, and 58 can be a buck, boost, or buck-boost converter, with the input ground connected to all of the output ground, USB_GND_x, connections. In other embodiments, the power circuit may be a controlled switch, implemented by one or more switching devices to pass power between input and output, as exemplified by block 82 in FIG. 11. The USB power supplies 54, 56, and 58 can include one or more integrated circuits, i.e. a port controller, for control, communications, and circuit protection.

In this example USB power delivery application, each individual USB power supply has a setting that limits the maximum power, as well as the maximum current and the specified voltages, that it can provide according to its capabilities. As provided, for example, by the USB Power Delivery 3.0 protocol, the downstream-facing USB power supply unit can negotiate a contract with any suitable USB load, i.e. power consuming device, to provide power at a voltage level and maximum current level consistent with these capability limits. In addition, the set of power supplies must collectively limit their total input power to be less than the maximum available power offered by their common power source (less a suitable amount to account for power dissipation in the power supplies). The negotiations to enforce the voltage, current, and power limits can be handled by a Local Policy Manger (abbreviated here as “LPM”) according to the USB-PD standard, or by other suitable systems or components. The LPM can be implemented as one or more integrated circuits, can be integrated with other functions of the USB power supply, or can be implemented in other suitable manners. For purposes of this description, the terms LPM or port controller will encompass the functions of power negotiation with peer power supply controllers, and communication (including negotiation) with the external device attached to the respective port.

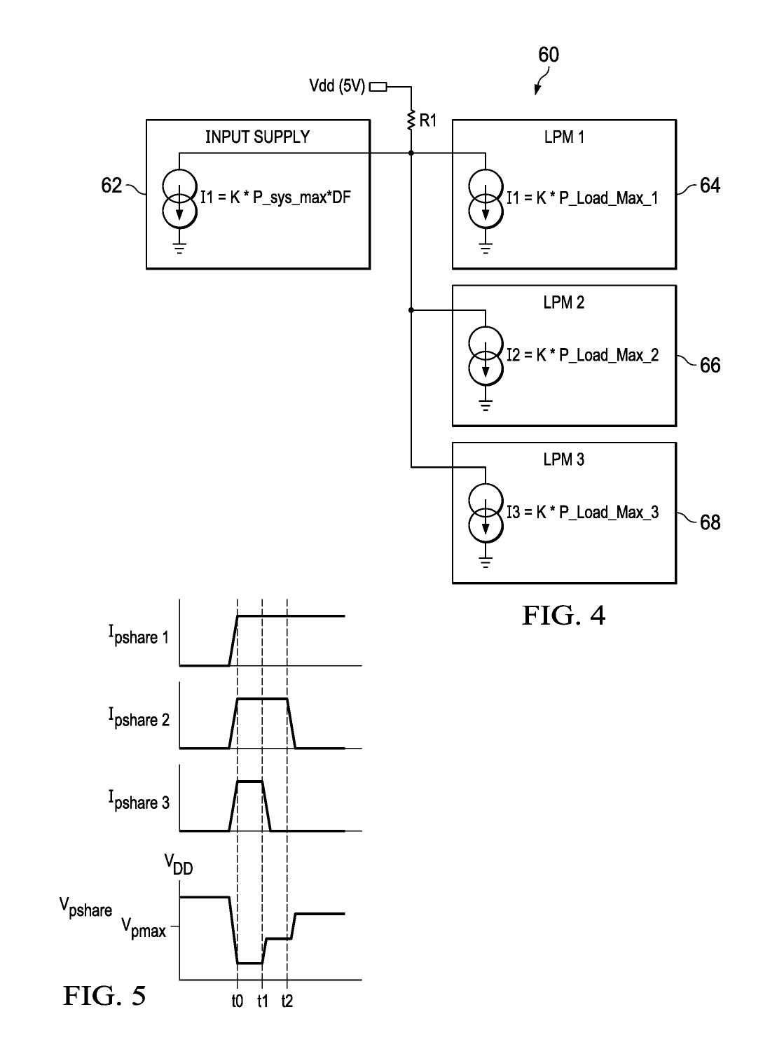

In one example embodiment, a controller interface associated with a port controller of each power supply 54, 56, and 58 provides for the common PSHARE connection among the LPM's associated with the controllers of the USB power supplies 54, 56, and 58. In the implementation, illustrated in FIG. 3, the PSHARE bus, the common tie point of the PSHARE terminals, connects through a single resistor to a supply or reference voltage that is common or set to the same level, e.g., 5 volts or ground, for all of the control IC's. For example, in FIG. 3, a resistor connects between the PSHARE bus and a common supply rail, designated as VDD. The resistor value can be chosen as inversely proportional to the maximum power that the set of USB supplies can collectively draw from the common source 52. The proportionality constant includes a factor equal to the maximum voltage drop that will be allowed across the PSHARE resistor. When drawing power from the common source 52, or when negotiating or preparing to do so, each USB supply 54, 56, and 58 can also draw a current at the PSHARE pin in proportion to the maximum amount of power it would provide or is providing to its load, as illustrated conceptually in FIG. 4, which shows the PSHARE circuit elements associated with 3 power supply controllers.

The optional connection from the input source to the PSHARE bus shown in FIG. 3 as PSHARE (optional) and FIG. 4 as PWR_DERATE can be used to enforce a power derating factor based on temperature or one or more other conditions. As shown in the embodiment of FIG. 4, the derating factor (DF) can equal zero under normal conditions and vary in response to temperature under other conditions. The input supply can also drive current into the power sharing bus if it needs to make adjustments to the available power (P_Sys_Max) without changing the value of resistor R1. As another example, a battery management system can use cell temperatures, cell voltage, and other factors such as battery life considerations, to derate the total power that the USB power supplies 54, 56, and 58 can draw from the battery 14. Additinally, any of the controllers of the USB power supplies 54, 56, and 58 can adjust its PSHARE pin current draw to account for internal losses expected due to its operating power efficiency at a negotiated power condition, can account for efficiency effects of operating temperature conditions, and can perform other suitable functions.

In addition, the negotiated power level of each USB power supply 54, 56, and 58 might not be drawn continuously but it can be reserved by the load to be sure it's available when needed. Prior to committing to provide a negotiated amount of power to a USB load, each controller and power share interface of USB supply 54, 56, and 58 can verify that the PSHARE pin voltage indicates sufficient headroom to support the current that it will draw to reserve this amount of power. The controller can do so by drawing the appropriate PSHARE current during the negotiating process, or in other suitable manners.

Since the power supplies 54, 56, and 58 have a common source 52, the PSHARE currents can also be considered as proportional to the USB power supply input currents that would be drawn at the reserved or negotiated power level. The maximum allowed PSHARE voltage drop can then correlate to the maximum output current that the common input source 52 can provide, in this embodiment. To ensure that the load power of each USB supply 54, 56, and 58 is being kept at or below the reserved power level, and to fully and reliably use the power available from the input source 52, each USB supply can use an accurate current sensing means such as a temperature stable sense resistor to measure the load current or the input current of each USB supply, or other suitable means.

FIG. 4 is an illustration of a system for power sharing via current sources in the Local Policy Manager (LPM) and interfaces of each USB power supply (or USB port) controller, in certain example embodiments, denoted generally as 60. The system 60 includes Local Policy Manager (LPM) 64, 66, and 68 of the controllers of each power supply 54, 56, and 58. Each LPM 64, 66, and 68 can also include an arbitration interface to address the case where two or more of the USB supplies 54, 56, or 58 attempt to reserve power at the PSHARE pin simultaneously prior to committing to provide the corresponding power level to the USB load. The arbitration interfaces can take advantage of addresses or priority codes assigned to each USB supply. Such addresses or codes can be determined by pin-strapping, i.e., tying address pins of a controller high or low, or leaving the pin high impedance, to assign a unique address or priority to each controller, by connecting different-valued resistors between ground and a separate designated pin of each control IC, or by other suitable manners. These methods of assigning addresses, such as pin-strapping, are common in systems with multiple controllers connected to a common communications bus. For example, in FIG. 3, there are two address pins tied to GND or VDD to assign unique addresses to each of the three power supply controllers. The address pins are not required, as addresses can be assigned by other hardware or software means. In any case, the assigned addresses or priorities can be used by the controller to determine different pre-programmed time delays after which each USB supply would release its additional power share claim on the PSHARE pin, thus leaving the power available to the claimant(s) with the highest priority setting(s), as indicated by the longest delay time(s). The time delay increments can be selected so as to prevent any race conditions.

Referring now to FIG. 5, illustrated is an example embodiment of PSHARE terminal voltages and currents of 3 power supply controllers under a priority-based delay scheme when 3 loads simultaneously request power. At time t0, all 3 of the controllers respond by drawing current from the PSHARE bus as they each attempt to reserve the requested amounts of power. Detecting that the PSHARE voltage has dropped below the PMAX threshold corresponding to the maximum available power, the controller representing the lowest priority, in this case #3, stops drawing current at time t1. With the PSHARE voltage still below the PMAX threshold, controller #2 with the next lowest priority stops drawing current after an additional delay at time t2. As a result, the PSHARE voltage rises above the PMAX threshold, and controller #1 can then confirm it will deliver the requested power, while the other two controllers will communicate that the requested power is not available.

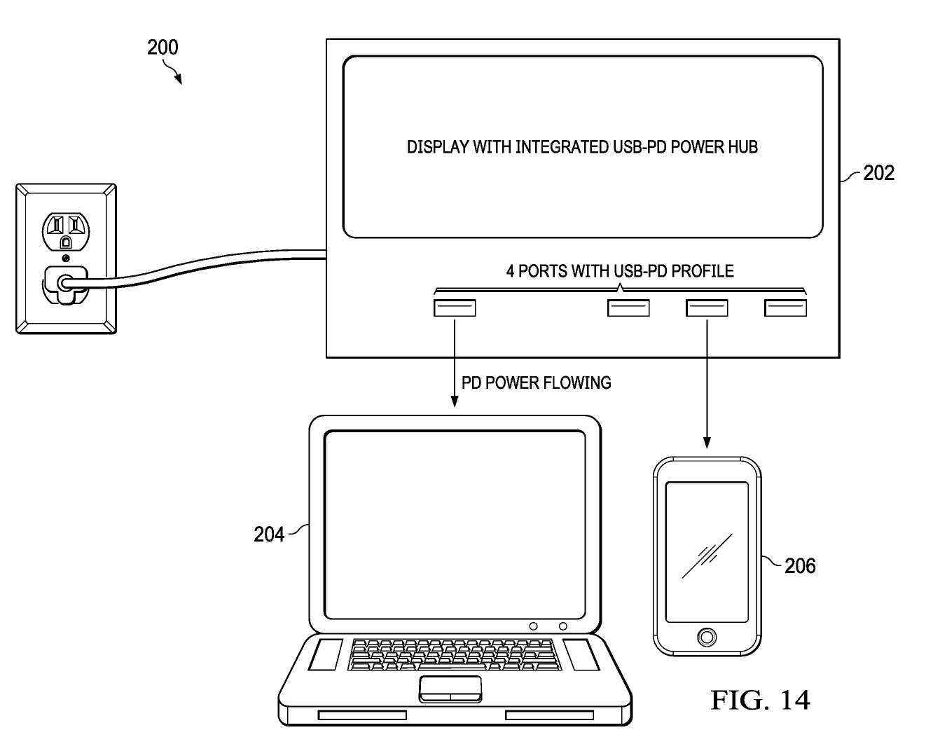

As an alternative, instead of operating only on first-come/first-serve or address-based priorities, the power supply controllers 54, 56, and 58 can support multiple loads at reduced power levels regardless of the timing or port priority of their connection. For example, in the USB-PD system 202 shown in FIG. 14, a notebook computer 204 can be plugged into a host system port for receiving power to operate and charge it's battery at the maximum allowable rate, and then a cellphone can later be plugged into another port from the same system 202.

In order to accommodate the cellphone, the USB-PD system 202 can reduce the power supplied to the notebook computer 204 such that it can still operate but with a reduced rate of battery charging. The following variation of the PSHARE scheme can accommodate such power adjustments. Besides its reserved power level, each source port controller can have received from its associated sink port controller a Minimum Operating Current field to which it can drop to, in order to share power with other controllers. For example, the USB-PD R3_v1.0a standard defines the Minimum Operating Current field in section 6.4.2.9 and defines a Give Back capable flag in 6.4.2.2 that the sink port controller can use to indicate that it will reduce its loading to this level in response to a GoToMin message from the source port controller, or other suitable controls can also or alternatively be used. Upon detecting that the PSHARE resistor voltage drop exceeds the threshold, due to one or more of the controllers requesting to reserve more power than that available from the shared input source, each controller that is willing to reduce its power can ramp down its PSHARE current at a rate proportional to the amount by which it is willing to reduce its power draw. The current ramps would be stopped when the PSHARE resistor voltage drop goes back above the threshold, with appropriate hysteresis.

In case the loads are not sufficiently flexible, for example not providing a Minimum Operating Current below the maximum negotiated operating current, thus being unable to resolve conflicts, a priority scheme can be combined with the current ramping scheme. To support this scenario and prevent a transient overload condition in the event that one supply is already providing power and has agreed to reduce it, the following sequence of events could then take place, each with durations specified by the design:
1) PSHARE voltage allowed to stabilize. This would also be the waiting period in case none of the controllers back down their PSHARE currents;
2) if the PSHARE resistor voltage drop still exceeds the system threshold, then the controllers with the newly connected loads can back down their requested power according to the connection timing and port address hierarchies. Depending on the system configuration, a controller with a lower priority can also back down its reserved power from a previously negotiated level;
3) power supply controllers can then notify their load controllers as needed about their newly agreed power levels; and
4) power supplies adjust their powers to the newly agreed levels in one of the following ways:
   a. power ramp rates are either in fixed proportion, same for all power supplies, to the PSHARE current ramp rates; or
   b. supplies that reduced their PSHARE currents first reduce their power draw during a fixed duration after which the other supplies are allowed to increase their power draw according to their new PSHARE currents.

The current Rev 3_v1.0a USB-PD protocol includes a GotoMin message for a source port controller to send a sink port controller to its Minimum Operating Current, but it can also send a message indicating a lower available current and renegotiate to that level if it is larger than the Minimum Operating Current. The protocol also includes PS_RDY messages for a source to communicate that it is ready for the sink to transition to an agreed power level.

USB-PD messages also includes maximum allowed load current slew rates but the actual rate can be slower. In option 4b above, the power supplies might not directly control the power draw of their loads, so once they give the go-ahead, they may not be able to control the ramp rate.

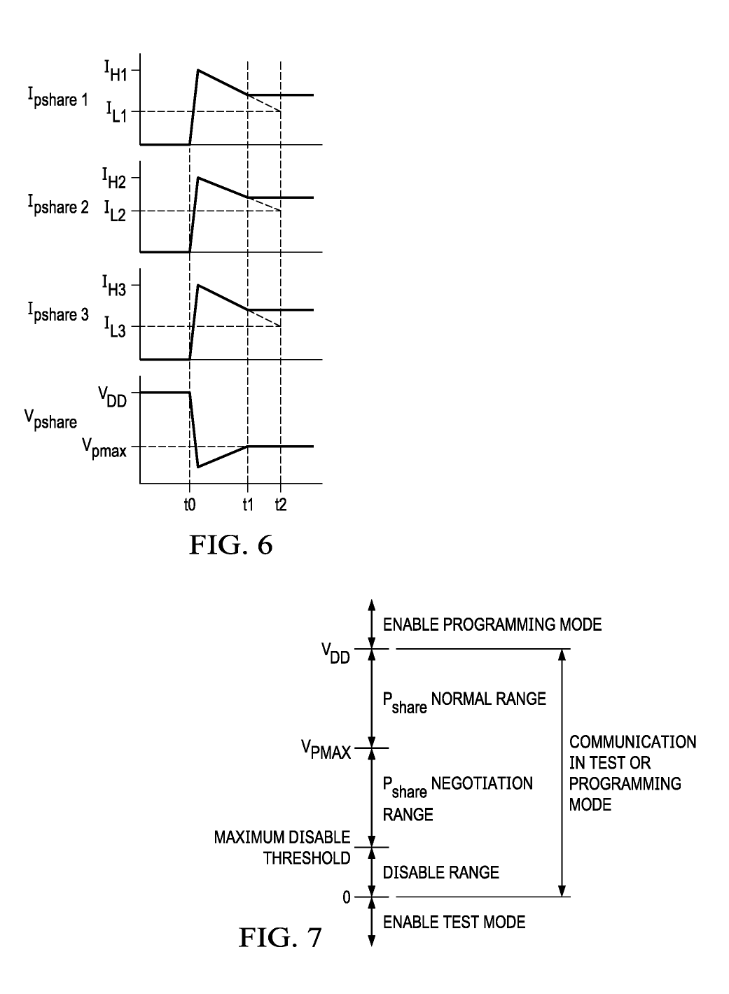

FIG. 6 illustrates a current ramping scheme as applied to the scenario of 3 loads all requesting power at the same time, in certain example embodiments. At time t0, all 3 controllers start drawing PSHARE currents corresponding to the full requested power levels, designated as IH1, IH2, and IH3. After detecting that the PSHARE voltage is below the PMAX threshold, the controllers ramp their currents down, each controller at a rate that would get the current at time t2 to that controller's respective lower current thresholds, i.e. IL1, IL2, and IL3, corresponding to the absolute minimal power levels required by their loads. As can be seen by the different ratios of IHx to ILx, some of the loads are more flexible than others. At time t1, however, the controllers detect that the PSHARE voltage has risen above the PMAX threshold, so the controllers stop the current ramps and hold their PSHARE current values, which then dictate what power levels they will agree to deliver to their respective loads.

In case any power supply has a deficit between its reserved power and the full power requested by its load, it's respective controller can periodically check to see if the PSHARE resistor voltage drop has fallen below a threshold, e.g. original threshold less some hysteresis, as an indication of available power and attempt to reserve some or all of the newly available power to fulfill its deficit.

FIG. 3 also shows optional connections from the PSHARE bus to a system enable line and to a programming line, reflecting that the single-wire power sharing line can serve these additional functions which can be designed to avoid interference with the power sharing functionality. For example, as shown in FIG. 3 with the PSHARE resistor connected to the positive voltage rail, the enable function can be implemented with a device that has a high output impedance to enable the power supplies but actively pulls the PSHARE line below a threshold voltage, e.g. well below the threshold corresponding to the maximum available input power, to disable the power supplies. To support additional needs for an integrated circuit, the programming connection might also get the controller into a programming mode, or a test mode, by applying a specified voltage or signal to the PSHARE line during a specified time window of the controller initialization sequence. Once a programming or test mode has been entered, the full supply range of the PSHARE bus could be used for 1-way or 2-way communication with the programming or test-mode control host.

Referring to FIG. 7, illustrated is a diagram showing the utilization of the voltage range of a PSHARE pin with combined enable/disable and programming/test mode functions, according to certain example embodiments. The diagram shows various thresholds for a multi-function PSHARE pin and the utilization of the voltage range, in accordance with certain example embodiments. During normal operation, the voltage can be in the PSHARE normal range in the absence of load-supply negotiations. During negotiations, the voltage could temporarily go below PMAX into the negotiation range. To prevent unintentional disabling of power supplies, the controllers can actively clamp their PSHARE currents as the PSHARE voltage approaches the maximum disable threshold. Appropriate tolerances, hysteresis, and margins can also or alternatively be added to the thresholds beyond what is shown.

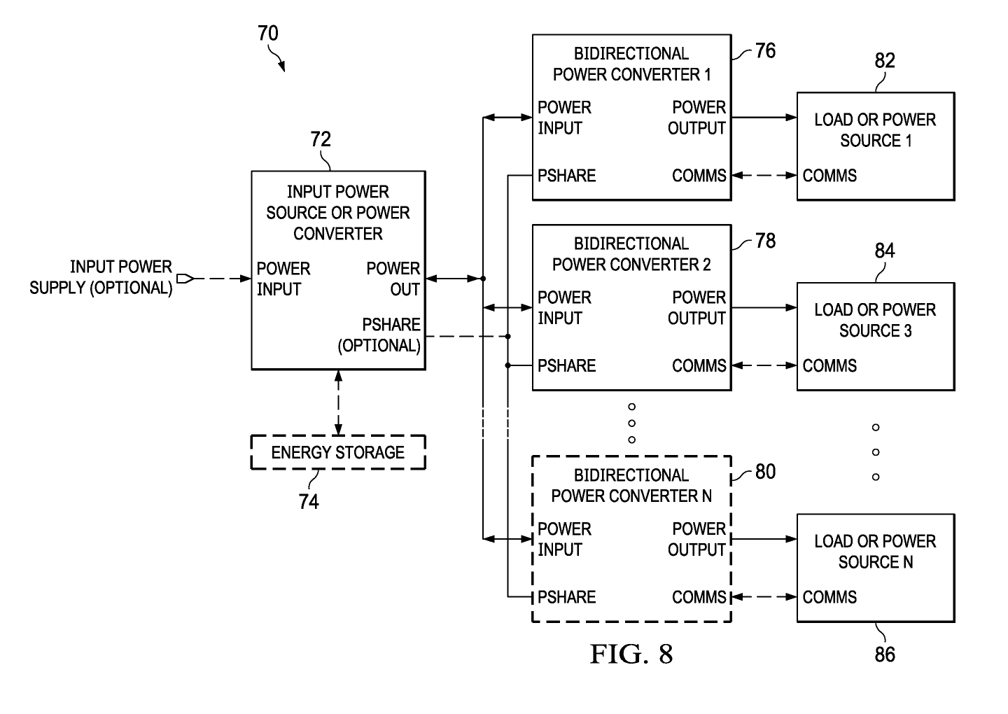

Referring to FIG. 8, illustrated is a multiport power system with bidirectional power flow, according to certain example embodiments, denoted generally as 70. The system includes a common power source 72, optional battery 74, bidirectional power supplies 76, 78, and 80, and a load and/or power source 82, 84, and 86. Any of the power supplies 76, 78, and 80 can receive power for the system at times instead of providing power to an external device. In this embodiment, the power supply can supply or draw a current in the opposite direction so as to reduce the PSHARE voltage drop in accordance with the additional system power that is available. However, the system 70 can accommodate having the power readily removed, e.g., by unplugging the external device providing the power. The controllers of the power supplies 76, 78, and 80 can use a single wire alert pin to signal loss of a power source, thereby allowing the system 70 to react quickly when such event occurs so at to avoid an overload-induced brownout or dropout of the input source.

A variation of the embodiments of systems presented herein can have the PSHARE resistor connected from the PSHARE bus to ground and controllers supplying instead of sourcing currents to the PSHARE bus. In either case, it is the voltage drop across the resistor that is measured as an indication of reserved power relative to a maximum system power threshold.

In another example embodiment of the systems presented herein, the system can use different types of signaling over the PSHARE connection, e.g. a 1-wire PSHARE connection. For example, rather than applying currents in proportion to requested power draw, each controller can apply periodic pulses of current or voltage to the PSHARE bus. Current pulses would work in conjunction with a resistor from the PSHARE bus to ground or to a supply rail. Voltage pulses can be applied to a common bus with high impedance applied between pulses, and no external resistor would be needed. In this exemplary embodiment, each controller can internally include a weak pull-up resistance from the PSHARE pin to the supply rail and the controller can actively pull the PSHARE bus down to ground for a duration proportional to the requested power, plus some offset to give a minimum pulse width at zero power. The pulses can be sequenced according to the addresses or priority codes of each controller. The controller with the first address or priority can dictate the pulse frequency, and the others can apply their pulses in turn after detecting that the previous pulse had terminated.

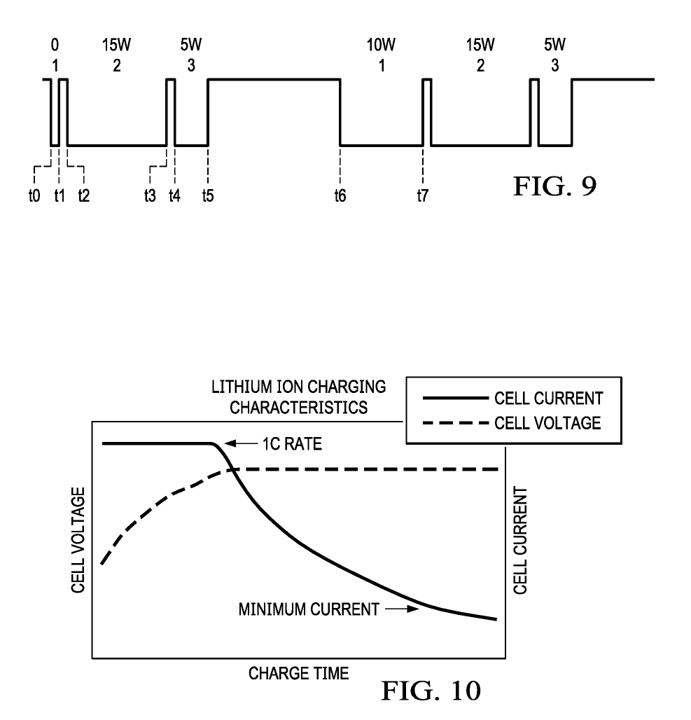

Referring now to FIG. 9, illustrated is a diagram of a PSHARE bus signal with any of the systems presented herein, according to certain example embodiments. The diagram illustrates the case wherein one of the controllers wants to reserve power for its load while the other two have already reserved their respective power levels. In the diagram, the PSHARE bus signal uses logic-low voltage pulse durations in proportion to requested power. The numbers above the low pulses, 1, 2, and 3 indicate which controller pulled the bus low for that duration and what power level, 0, 15, 5, 10, 15, and 5 watts is represented by that pulse. Controller #1 begins the cycle at time t0 and applies a minimal duration pulse terminating at time t1 to indicate zero power draw. After a short delay, the second controller applies a pulse between times t2 and t3, representing a power of 15 W. Following a similarly short delay after t3, controller #3 applies a pulse between t4 and t5 representing 5 W. The bus is held high by the pull-up resistances for the duration of the cycle. At time t6, controller #1 begins the pulse train again, but this time controller #1 applies a pulse of substantial width as it is attempting to reserve 10 W of power. The other two controllers apply the same pulse width as in the previous cycle representing no change requested or offered in their power draw. The controllers can be programmed with a pulse train frequency, controller #1 can use this for pulse timing, and the combined duty cycles of the pulses, less the programmed offset durations, can be counted by each controller against a pre-programmed duty cycle corresponding to the maximum available input power. A margin can be provided between the maximum combined duty cycles, based on all of the individual maximum power levels, and 100% duty cycle to allow for the delays between the controller pulses and a minimum off-time at the end of the cycle, e.g. t5 to t6, that can be longer than the delay between pulses, so that the controllers can detect when a new pulse train cycle has begun. This exemplary embodiment can use sequential addresses, with no skipping, so that each controller can correlate its own address with its order in the pulse train. Schemes previously described for reducing or canceling power requests can also or alternatively be applied here. For example, power requests can be ramped down by repeatedly reducing the pulse durations by a discrete amount from one cycle to the next. This embodiment can be advantageous for a digital system that uses pulse counters instead of requiring accurate current sources or voltage measurements. However, many cycles might be needed for current ramping. In general, the analog approach of the current sources in FIG. 4 gives the advantage of speed as compared to digital communication approaches that require messages to flow back and forth among multiple controllers in order to complete a negotiation.

The variation of the aforementioned systems described relate to communication of power allocations among the controllers in the multi-port power systems. Frequently, however, the port power supplies may not use all of their allocated power due to the varying power needs of external loads having dynamic usage profiles and/or battery charging profiles that gradually change power draw. As such, the use of current summing controls to adjust instantaneous input current limit for battery charging controls to account for dynamic variations in power flows that offset available power for the battery charging is needed.

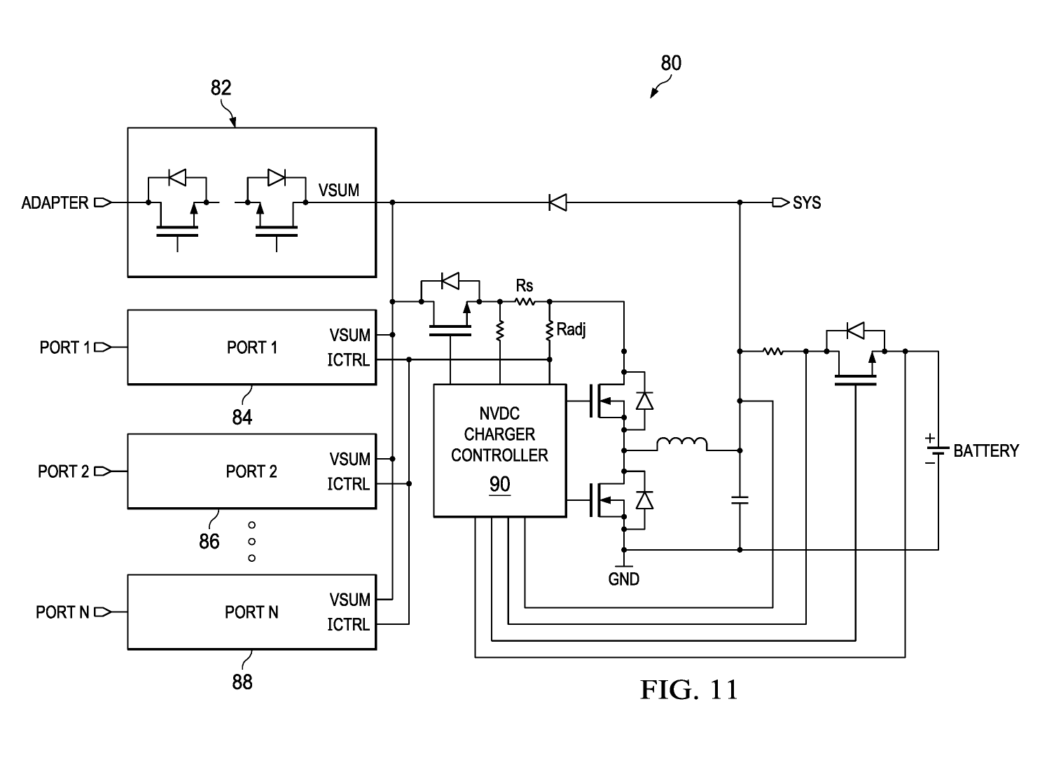

Referring now to FIG. 10, illustrated is a typical charging profile for a Lithium ion battery, as commonly used in a cellphone that might be supplied by port power supply, according to certain example embodiments. This profile provides an example of a load with non-constant power draw. In this case, power gradually rises during the constant current period as voltage increases, and then power drops during the constant voltage period and ultimately tapers off with the current. In the case that there is an external power source and the loads connected to the port power supply are not utilizing all of their power allocation, the multi-port power system can dynamically use the remaining power to charge its own battery. However, the system can quickly detect any changes in external port loading and adjust the battery charging power accordingly to avoid under voltage disturbances on the common bus that could cause devices to shut down or behave erratically.

The latency of digital communication schemes can preclude their use in this application. Instead, the system can use a common low power bus with port control circuits injecting currents in proportion to their instantaneous power rather than their allocated power. In summary of this approach for optimizing the charging of the system's internal battery, the system can:
communicate instantaneous current—where each controller drives a current, sourcing or sinking, into a common PSHARE-type bus, in proportion to that being drawn by its power supply from the common input source;
currents are summed together into a resistance;
a control voltage develops across the resistor wherein this control voltage represents an adjustment to the amount of current available on the bus from which the battery charger can draw its current; and
the resulting charging current is controlled so as not to overdraw the common bus.

Referring now to FIG. 11, illustrated is a multi-port power supply system, according to certain example embodiments, denoted generally as 80. The system 80 comprises adaptor 82, port power supplies 84, 86, and 88, NVDC charger controller 90, and battery source. NVDC stands for Narrow Voltage DC and refers to a notebook computer power system architecture where the system internal power is supplied at the battery voltage. Reference: Evaluation of Narrow Vdc-Based Power Delivery Architecture in Mobile Computing System, Xiaoguo Liang, Peter Li, and Gnanavel Jayakanthan IEEE Transactions on Industry Applications (Volume: 47, Issue: 6, November-December 2011, http://ieeexplore.ieee.org/document/6022776/). The port power supplies 84, 86, and 88 are illustrated along with adaptor 82 that can pass current directly from an adapter designed to provide the preferred voltage onto the VSUM bus for the multi-port system 80. The NVDC charger controller 90 can be an integrated circuit, e.g., available from a 3^{rd} party manufacturer. A key interface feature utilized here is a current sensing resistor used by the charger as a feedback control input to limit the current drawn from the common VSUM node by adjusting the power it provides to the system 80, including the battery.

The system 80 can include a means to verify that the adapter 82 is a known device with known current capability or a means for the adapter 82 to communicate current capability to the charge controller 90 to set a baseline current limit. As any of the port power supplies 84, 86, and 88 draw power from the common VSUM terminals, they can also draw a much smaller proportional current from their common ICTRL terminals, the proportionality constant being a fixed, programmable, or configurable parameter for the system 80. The currents are summed to generate a voltage across the resistor R_{adj}, which adds to the current sense signal detected by the charger controller 90. Effectively, the input currents from the port power supplies 84, 86, and 88 subtract from the available adapter current to reduce the current limit of the charger controller 90 so as to prevent it from over-drawing the VSUM bus, thus preventing disturbances or interruptions to the system power flow while allowing the maximum available power to be used for charging the system's internal battery. Note that the ICTRL currents flowing through R_{adj} are many orders of magnitude smaller, typically less than 1 mA, as compared with the Amperes of current typically flowing through the sense resistor Rₛ, so the ICTRL would not affect the charger operation other than through the desired means of changing the sensed current value.

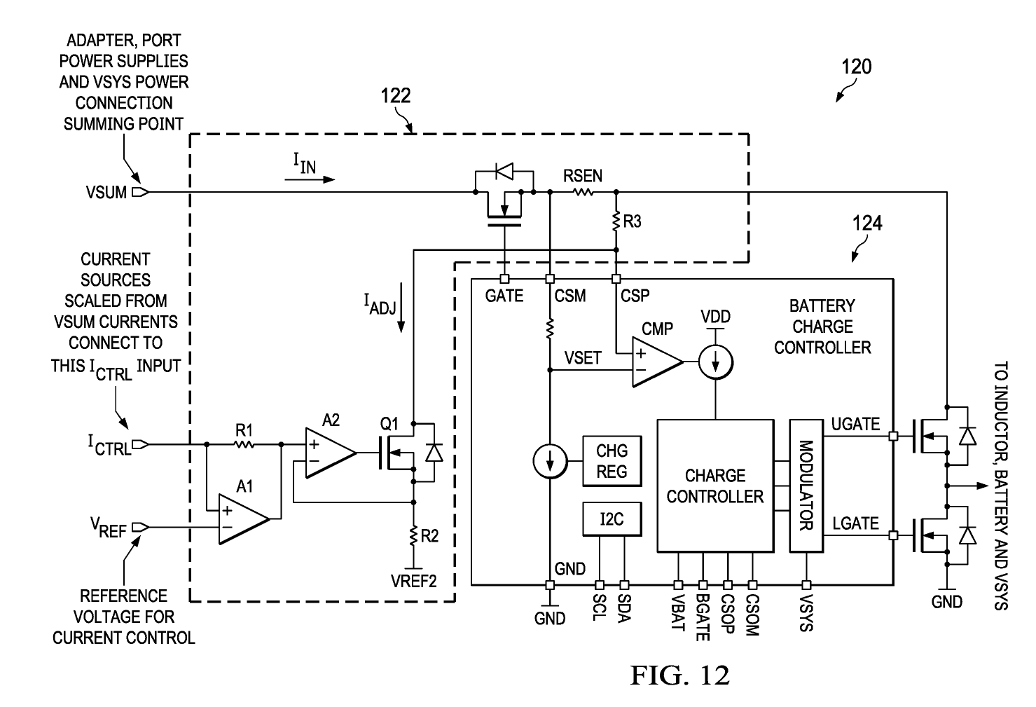

Referring now to FIG. 12, illustrated is an interface system and controller with charging optimization to work with low voltage current sources on port power supplies, according to certain example embodiments, denoted generally as 120. The system 120 comprises an interface system 122 and the charge controller 124. Interface system 122 includes the previously, or version thereof, current sense circuit and other supporting circuitry to interface with the charge controller 124. The battery charger controller 124 includes a buck regulator, modulator block with UGATE and LGATE drivers and external MOSFETs, for providing power to the system and the battery at the correct charging voltage, an I²C serial digital communication interface, see UM10204, I2C-bus specification and user manual, Rev. 6-4 Apr. 2014, NXP Semiconductors, with terminals SCL and SDA.

The system 120 includes ICTRL pins of the port power supplies 84, 86, 88 that can connect to a high voltage node, e.g. 15-20V typical for a notebook computer. The current source outputs at the ICTRL terminals of the controllers of FIG. 11 could be operated at low voltage below a common low voltage I.C. supply rating, such as 5.5V or 3.6V. In this case, the ICTRL pins can connect to an interface circuit 122 along with a charge controller circuit 124. The aforementioned input current sensing circuit with amplifier CMP compares the sensed and adjusted input current to a current limit threshold VSET set by a charger register, illustrated as CHG REG, and additional charging control and battery protection circuits connected to the BGATE, CSOP, CSOM, and VBAT terminals. VSYS is the output voltage feedback of the buck regulator. The interface circuit 122, comprising op-amps A1 and A2, resistors R1 and R2, and MOSFET Q1, sums the currents at the ICTRL node and drives a proportional current I_{adj} through R3 to adjust the sensed input current of the charging controller as previously described. The ratio between the current I_{adj} and the summed ICTRL currents is set by the ratio of R1 to R2, assuming that VREF2=VREF. The reference voltages VREF and VREF2 are selected to provide an offset voltage at the ICTRL terminals of the port supplies (set by VREF) and to create an offset in the current limit adjustment. With no external loading reported by the port power supply controllers through their ICTRL currents, the positive or negative offset of the current limit adjustment is equal to (VREF−VREF2)/R2.

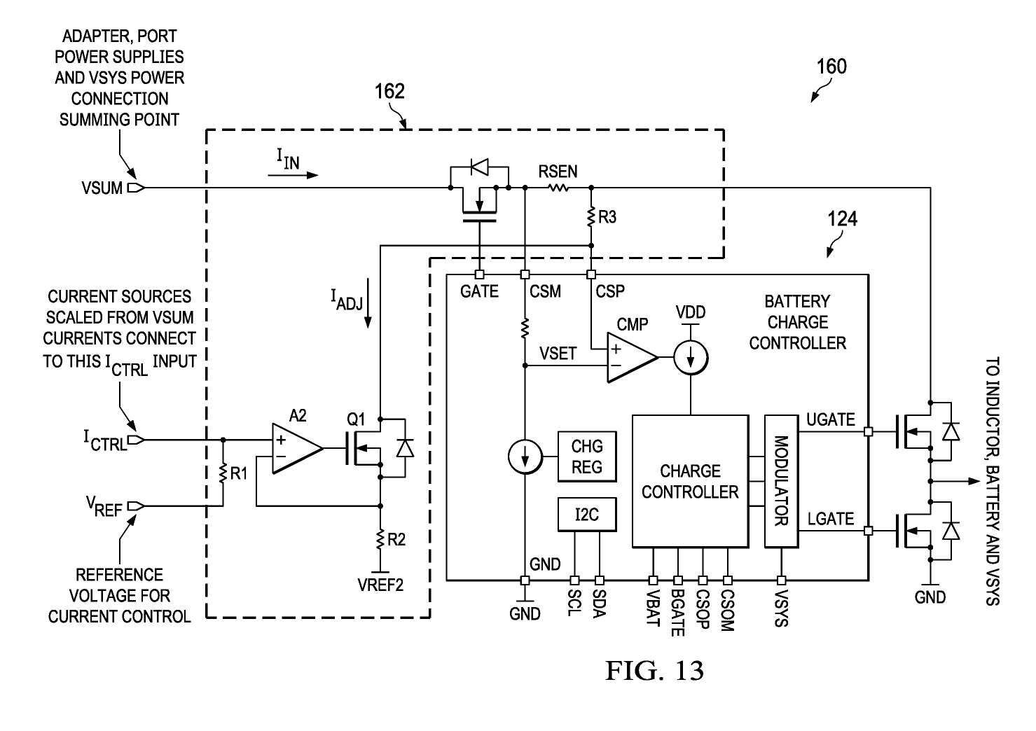

Referring now to FIG. 13, illustrated is an alternative embodiment of the interface system and controller, according to certain example embodiments, denoted generally as 160. The system 160 comprises interface circuit 162 and charge controller 124. The interface circuit 162 comprises a single op-amp A2 and works with currents being sourced from ICTRL pins of the port power supply controllers, that is with terminal currents flowing in the opposite direction of their VSUM terminal currents.

In the case that a port circuit of FIG. 11 draws a fixed amount of power from an external source, the port circuit 84, 86, and 88 could set its ICTRL current to be in the opposite direction relative to the case where it is supplying power to an external load. (With the interface circuit of FIG. 11 or FIG. 12, the ICTRL terminal current should be of the same polarity as its VSUM current. With the circuit of FIG. 13, the polarity of the ICTRL current should be reversed relative to its VSUM current.) This way the current limit can be adjusted upward to account for the additional power available from the external source. This method works when the port circuit is supplying current to the VSUM terminal at its current limit threshold so that it is not regulating the voltage at VSUM. To account for cases where a port circuit might be regulating the voltage at VSUM, the preferred method of changing the input current limit of the charger controller can be through system communications, which can use the I²C bus of the charging controller and/or an additional system controller with a separate I²C bus communicating with the port controller circuits, or some other means of communication may be used. While the battery charging controls can limit battery charging to safe levels and ultimately draw no more current from the input than is used by the charger and the rest of the system, the interface circuit is designed so that a net ICTRL current cannot increase the input current limit; it can reduce the current limit for the baseline value. Any system communication and controls that increase the baseline current limit, i.e., CHG register value, due to additional external sources would also take into account the maximum allowed input current limit of the system.

The port power supplies can communicate their current limit thresholds rather than their contracted maximum load current. These values can essentially be the same, but the current limit threshold can be an easier signal to provide, especially in an analog domain.

A system could use either or both types of power sharing buses—one for allocation of power to quickly set contract commitments and the other for dynamic tracking of loads to optimize the utilization of available power.

The arbitration or even the power availability tracking can be done with digital communication among the IC's using a protocol such as SPI, I2C, SMBus, PMBus, or a proprietary protocol such as SemPulse. If the power availability tracking and reserving is done through communication and some combination of digital logic and firmware on the IC's, the systems presented herein can operate in conjunction with the PSHARE bus, can replace the function of the PSHARE bus and associated arrangements, or can perform other functions. In replacing the PSHARE bus with digital communications, firmware can utilize a digital algorithm analogous to the power sharing scheme described in this disclosure.

In a digital version of the PSHARE bus, a register can represent the available power, can be broadcasted on the bus periodically or upon request, or other suitable configurations can be used. The host can decrement the register when power is successfully reserved by a power supply controller. Some of these protocols, such as I2C and its derivatives, can require additional wires beyond the single-wire PSHARE bus described in the exemplary embodiments.

Existing methods can use software or firmware and digital communications among the USB power supply controllers, and typically a host or master controller to work out the arrangements for rationing out power from a limited input source. In general, particularly when there is a host or system controller, this communication path can have multiple additional purposes, such as upstream communication of faults and other status parameters from the USB ports. In addition the digital controllers typically have multiple activities, such as protection, monitoring, and interfaces to an operating system or user interface. Therefore, a fast response to power requests with the digital approach may require an expensive host controller to provide the requisite computing resources and processing speed, along with the communications. The described embodiments, on the other hand, optimize the system by off-loading the power sharing task to the controllers operating collectively through the PSHARE bus. In another alternative embodiment, the controller for one of the USB supplies, or some other digital controller in the system, can be designated as the master, such that the controller can be used to arbitrate conflicts, to approve all power delivery contracts for the system's USB supplies prior to commitments being made to USB load devices, or for other suitable purposes.

A controller can also be implemented using a general purpose I/O that can be configured to interface to the PSHARE bus with one or more of the aforementioned configurations and communication protocols. For example, the one GPIO can be capable of applying analog variable currents or logic-low signals of controlled pulse duration.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for delivering power between a common power source having a total deliverable system power and device loads connected to the ports of power supplies derived from the common power source, the system comprising:
a power sharing signal interface bus among two or more controllers for the ports of power supplies that determines power allowed by respective device loads; and
wherein any one the controllers receives a power level request from a device load and uses the power share signal interface to determine availability of excess system power reserves to support the request.

2. The system of claim 1 wherein the power share interface determines, in response to receiving the power level request, available system power and, in response, causes the system to redirect the requested power to satisfy the power level request by reducing the power of another load.

3. The system of claim 1 or 2 wherein the bus is a single wire interface.

4. The system of claim 1 or 2 wherein the interface includes a current driven into or out of the signal interface bus by a power supply controller in proportion to the power consumed, reserved, or requested by its respective power supply from the common source.

5. The system of claim 4 wherein one or more of the port power supplies can deliver power from the system or receive power to the system, and the direction of the current driven onto the signal interface bus indicates whether the power supply is delivering or receiving power, and received power can be used to offset total usable system power.

6. The system of claim 1 or 2 wherein the bus includes a resistor for summing currents.

7. The system of claim 4 wherein total deliverable system power corresponds to a voltage threshold on the signal interface

8. The system of claim 3 wherein the single controller terminal that interfaces to the signal bus is also used to enable and disable the power supply, and may also be used to put the controller into a test mode and/or a programming state.

9. The system of claim 1 or 2 wherein relative priorities are assigned by the system to one or more of the power supplies enabling the respective controllers to resolve conflicting power requests through the interface bus.

10. The system of claim 9 wherein the controllers use signal durations in the order of their respective priorities to indicate power consumed, reserved, or requested by the respective power supply loads, wherein the total deliverable system power corresponds to a combined signal duration that is pre-determined in the system design or communicated by the system to the controllers.

11. A system for distributing sourced power among two or more loads wherein the power consumption of at least one of the loads can be modified, comprising:
a power sharing signal interface bus that determines power consumed by one or more device loads and causes the system to adjust the power of another of the device loads.

12. The system of claim 11 wherein the bus is a single wire interface.

13. The system of claim 11 wherein the interface includes a current driven into or out of the interface bus by a power supply controller in proportion to the current or power consumption of its respective power supply.

14. The system of claim 13 wherein direction and magnitude of the current indicates direction and magnitude of current or power flow.

15. The system of claim 11 wherein the signal bus includes a resistor for summing currents.

16. The apparatus of claim 15 wherein the resistor value is inversely proportional to the maximum power that the set of power supplies can collectively draw from the common power source.

17. The system of claim 11 wherein the load being adjusted is a battery charger.

18. The system of claim 11 wherein adjustment is made by adjusting sensed current or power of the controller for the adjustable load.

19. The system of claim 18 wherein adjustment of sensed current is done by adding a voltage between a power current sense resistor and the input of the current sense measurement; voltage proportional to the sum of the currents.

20. The system of claim 15 further comprising op-amp/MOSFET interface circuits used to level-shift, clamp and/or buffer current signal.

21. The system of claim 1 or 2 wherein the common power source can use the interface bus to adjust the effective deliverable power based on operating conditions such as temperature, or based on power requests or provisions communicated to the system through means other than the power sharing signal interface bus

22. The system of claim 7 wherein power allocations among power supplies are negotiated by ramping current into or out of the signal interface bus until the voltage threshold is reached.

23. The system of claim 9 wherein the controllers maintain signal interface current levels corresponding to requested power for durations corresponding to the assigned priorities of the respective controllers.
